(19) United States
(12) Patent Application Publication
(10) Pub. No.: US 2016/0120008 A1
(43) Pub. Date: Apr. 28, 2016

(54) MUSICAL DISPLAY DEVICE

(71) Applicant: Collin Sutherland, Florida, FL (US)

(72) Inventor: Collin Sutherland, Florida, FL (US)

(21) Appl. No.: 14/523,427

(22) Filed: Oct. 24, 2014

(51) Int. Cl. H05B 37/02; H05B 33/08; F21V 33/00; G08B 5/36

(52) U.S. Cl. CPC H05B 37/0236; G08B 5/36; H05B 33/0842; F21V 33/0056

(57) ABSTRACT

A musical display assembly includes a housing. A processor is coupled to the housing. An actuator is coupled to the housing and the processor to actuate and de-actuate the processor. An electronic memory is coupled to the housing and the processor. The electronic memory stores music. Each of a pair of speakers is coupled to the housing and to the processor to emit the music. A display is coupled to the housing and the processor. A plurality of light emitters is electrically coupled to a conductor. Thus, the light emitter may be displayed in a desired arrangement. A plurality of data ports is provided. Each of the data ports is coupled to the housing and the processor. The conductor is electrically coupled to a selected one of the data ports wherein each of the light emitter emits light in a pattern corresponding to a rhythm of the music.

### BACKGROUND OF THE DISCLOSURE

### Field of the Disclosure

The disclosure relates to display devices and more particularly pertains to a new display device for emitting light in a pattern corresponding to rhythm of music.

### SUMMARY OF THE DISCLOSURE

An embodiment of the disclosure meets the needs presented above by generally comprising a housing. A processor is coupled to the housing. An actuator is coupled to the housing. The actuator is electrically coupled to the processor to actuate and de-actuate the processor. An electronic memory is coupled to the housing. The electronic memory is electrically coupled to the processor. The electronic memory stores music. A pair of speakers is coupled to the housing. Each of the speakers is electrically coupled to the processor to broadcast the music. A display is coupled to the housing and electrically coupled to the processor to displays indicia relating to the music. Each of a plurality of light emitters is electrically coupled to a conductor such that the light emitters are evenly distributed along an entire length of the conductor. A plurality of data ports is provided. Each of the data ports is coupled to the housing. Each of the data ports is electrically coupled to the processor. The conductor is electrically coupled to a selected one of the data ports wherein each of the light emitter emits light in a pattern corresponding to a rhythm of the music.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a musical display assembly according to an embodiment of the disclosure.

FIG. 2 is a perspective view of an embodiment of the disclosure.

FIG. 3 is a top view of an embodiment of the disclosure.

FIG. 4 is a left side view of an embodiment of the disclosure.

FIG. 5 is right side view of an embodiment of the disclosure.

FIG. 6 is a schematic view of an embodiment of the disclosure.

### DESCRIPTION OF THE PREFERRED EMBODIMENT

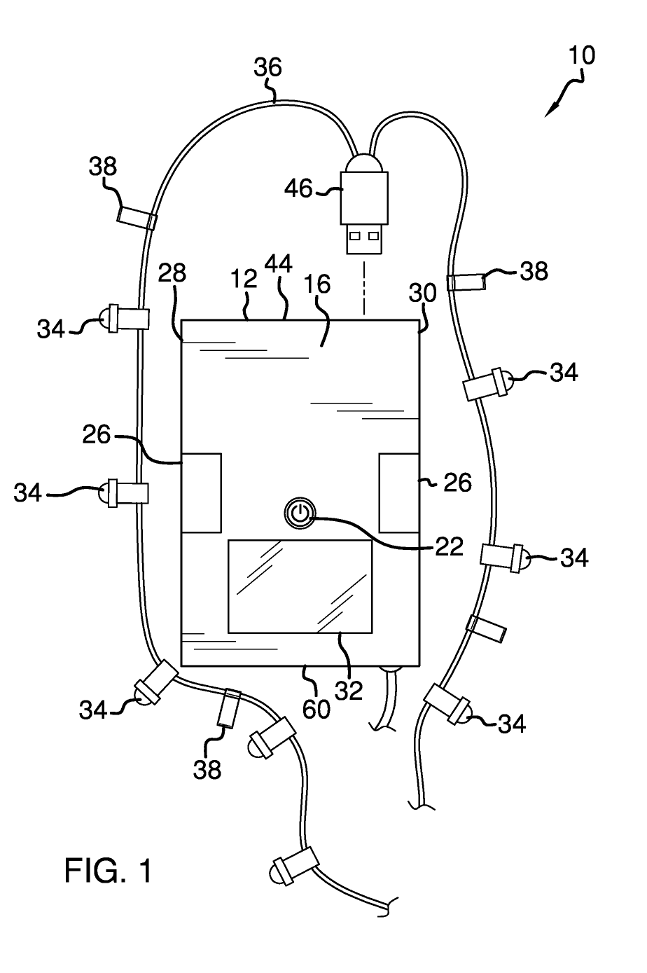

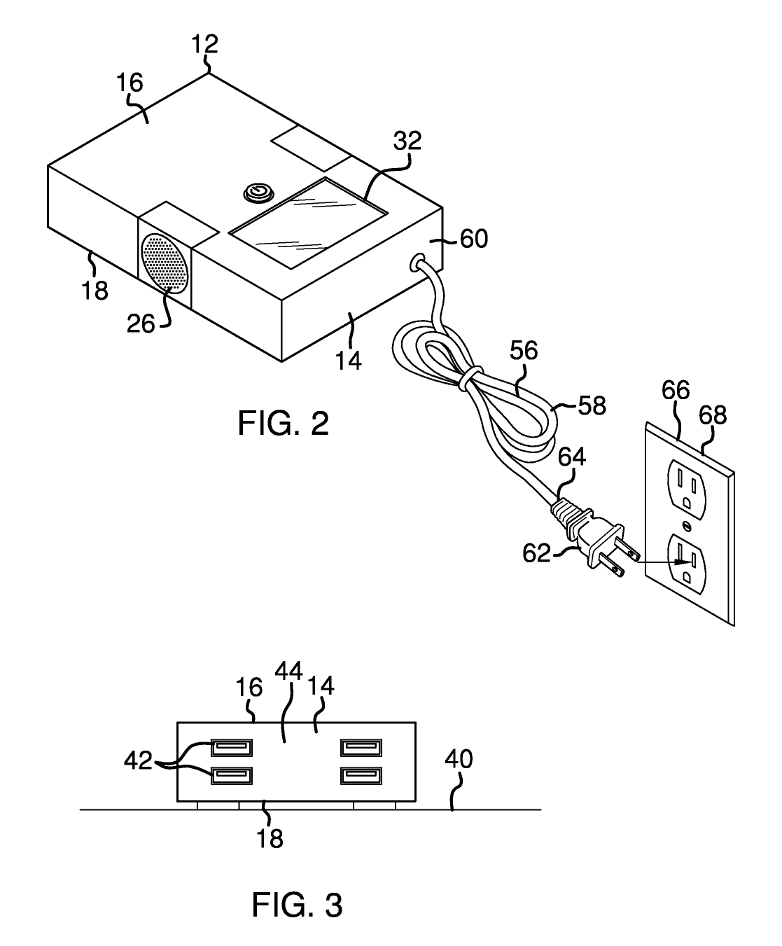

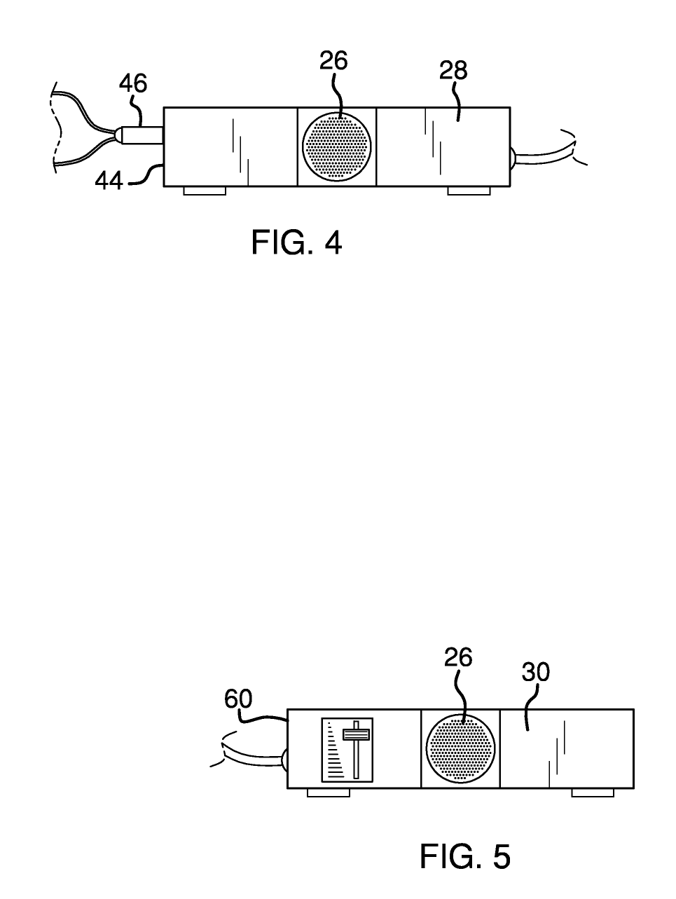

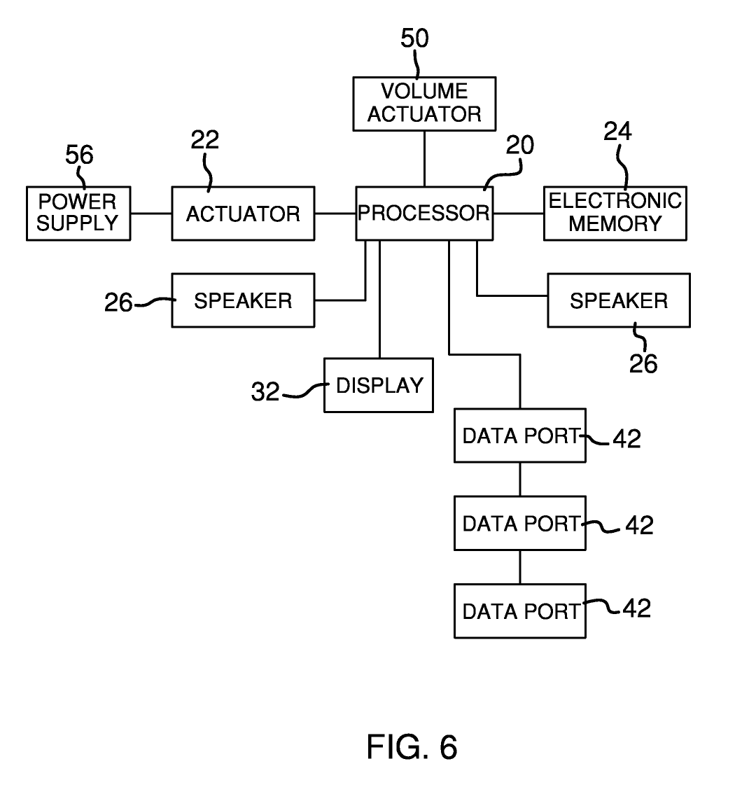

With reference now to the drawings, and in particular to FIGS. 1 through 6 thereof, a new display device embodying the principles and concepts of an embodiment of the disclosure and generally designated by the reference numeral 10 will be described.

As best illustrated in FIGS. 1 through 6, the musical display assembly 10 generally comprises a housing 12. The housing 12 has an outer wall 14 extending between each of a front wall 16 and a back wall 18 of the housing 12. A processor 20 is coupled to the housing 12. The processor 20 may be an electronic processor or the like. An actuator 22 is coupled to the front wall 16 of the housing 12. The actuator 22 is electrically coupled to the processor 20 to actuate and de-actuate the processor 20.

An electronic memory 24 is provided. The electronic memory 24 is coupled to the housing 12. The electronic memory 24 is electrically coupled to the processor 20. Moreover, the electronic memory 24 stores music.

A pair of speakers 26 is provided. Each of the speakers 26 is coupled to an associated one of a first lateral side 28 and a second lateral side 30 of the outer wall 14 of the housing 12. Each of the speakers 26 is electrically coupled to the processor 20 to emit the music. A display 32 is coupled to the front wall 16 of the housing 12. The display 32 is electrically coupled to the processor 20 to display indicia relating to the music. The display 32 may be a touch screen display or the like. The display 32 may be touched to select desired characteristics of the music.

A plurality of light emitters 34 is provided. Each of the light emitters 34 may be an LED or the like. A conductor 36 is provided. Each of the light emitters 34 is electrically coupled to the conductor 36. Moreover, the light emitters 34 are evenly distributed along an entire length of the conductor 36. The conductor 36 may be comprised of a flexible material to be displayed the light emitters 34 in a desired arrangement.

A plurality of clips 38 is provided. Each of the clips 38 is coupled to the conductor 36 such that the clips 38 are evenly spaced apart and distributed along an entire length of the conductor 36. The clips 38 engage a support surface 40 to retain the conductor 36 on the support surface 40. The support surface 40 may be a wall or the like.

Each of a plurality of data ports 42 is coupled to a top side 44 of the outer wall 14 of the housing 12. Each of the data ports 42 is electrically coupled to the processor 20. Each of the data ports 42 may be a USB port or the like.

A data plug 46 is provided. Each of a pair of ends 48 of the conductor 36 is electrically coupled to the data plug 46 to form a closed loop. The data plug 46 is removably insertable into a selected one of the data ports 42 wherein the data plug 46 is electrically coupled to the data port 42. The light emitters 34 are placed in electrical communication with the processor 20. Thus, each of the light emitters 34 emits light in a pattern corresponding to a rhythm of the music.

A volume actuator 50 is slidably coupled to the second lateral side 30 of the outer wall 14 of the housing 12. The volume actuator 50 is electrically coupled to the processor 20. Additionally, the volume actuator 50 controls a volume of the music emitted by the speakers 26. A plurality of pads 52 is coupled to the back wall 18 of the housing 12. Each of the pads 52 is positioned proximate an associated one of four corners 54 of the housing 12. Each of the pads 52 abuts the support surface 40.

A power supply 56 is electrically coupled to the actuator 22. The power supply 56 comprises a cord 58 extending outwardly from a bottom side 60 of the outer wall 14 of the housing 12. A plug 62 is electrically coupled to a free end 64 of the cord 58. The plug 62 is electrically coupled to a power source 66. The power source 66 may be an electrical outlet 68 or the like.

In use, the music to be played on the speakers 26 is selected using the display 32. The conductor 36 is arranged in the desired pattern. The assembly 10 may be utilized during holidays or other similar festive occasions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A musical display assembly comprising:
a housing;
a processor coupled to said housing;
an actuator coupled to said housing, said actuator being electrically coupled to said processor wherein said actuator actuates and de-actuates said processor;
an electronic memory coupled to said housing, said electronic memory being electrically coupled to said processor, said electronic memory storing music;
a pair of speakers, each of said speakers being coupled to said housing, each of said speakers being electrically coupled to said processor wherein said speakers emits the music;
a display coupled to said housing, said display being electrically coupled to said processor wherein said display displays indicia relating to the music;
a plurality of light emitters;
a conductor, each of said light emitters being electrically coupled to said conductor such that said light emitters are evenly distributed along an entire length of said conductor wherein said light emitter are configured to be displayed in a desired arrangement; and
a plurality of data ports, each of said data ports being coupled to said housing, each of said data ports being electrically coupled to said processor, said conductor being electrically coupled to a selected one of said data ports wherein each of said light emitter emits light in a pattern corresponding to a rhythm of the music.

2. The assembly according to claim 1, further comprising a data plug, each end of said conductor being electrically coupled to said data plug such that said conductor forms a closed loop.

3. The assembly according to claim 2, wherein said data plug being removably insertable into said data port wherein said data plug is electrically coupled to said data port such that said light emitters are placed in electrical communication with said processor.

4. The assembly according to claim 1, further comprising a plurality of clips, each of said clips being coupled to said conductor such that said clips are evenly spaced apart and distributed along an entire length of said conductor, said clips engaging a support surface such that said clips are configured to retain the conductor on the support surface.

5. The assembly according to claim 1, further comprising a power supply, said power supply being electrically coupled to said actuator, said power supply comprising a cord extending outwardly from said housing, said cord being electrically coupled to a power source.

6. A musical display assembly comprising:
a housing;
a processor coupled to said housing;
an actuator coupled to said housing, said actuator being electrically coupled to said processor wherein said actuator actuates and de-actuates said processor;
an electronic memory coupled to said housing, said electronic memory being electrically coupled to said processor, said electronic memory storing music;
a pair of speakers, each of said speakers being coupled to said housing, each of said speakers being electrically coupled to said processor wherein said speakers emits the music;
a display coupled to said housing, said display being electrically coupled to said processor wherein said display displays indicia relating to the music;
a plurality of light emitters;
a conductor, each of said light emitters being electrically coupled to said conductor such that said light emitters are evenly distributed along an entire length of said conductor wherein said light emitter are configured to be displayed in a desired arrangement;
a plurality of data ports, each of said data ports being coupled to said housing, each of said data ports being electrically coupled to said processor;
a data plug, each end of said conductor being electrically coupled to said data plug such that said conductor forms a closed loop, said data plug being removably insertable into a selected one of said data ports wherein said data plug is electrically coupled to said data port, said light emitters being placed in electrical communication with said processor wherein each of said light emitter emits light in a pattern corresponding to a rhythm of the music;
a plurality of clips, each of said clips being coupled to said conductor such that said clips are evenly spaced apart and distributed along an entire length of said conductor, said clips engaging a support surface such that said clips are configured to retain the conductor on the support surface; and
a power supply, said power supply being electrically coupled to said actuator, said power supply comprising a cord extending outwardly from said housing, said cord being electrically coupled to a power source.
